(19) United States
(12) Patent Application Publication
(10) Pub. No.: US 2024/0295267 A1
(43) Pub. Date: Sep. 5, 2024

(54) SEALING GASKET AND VEHICLE COMPRISING SUCH A SEALING GASKET

(71) Applicant: VOLVO TRUCK CORPORATION, Göteborg (SE)

(72) Inventor: Raphael BOST, Toussieu (FR)

(73) Assignee: VOLVO TRUCK CORPORATION, Göteborg (SE)

(21) Appl. No.: 18/593,409

(22) Filed: Mar. 1, 2024

(30) Foreign Application Priority Data
Mar. 2, 2023 (EP) 23159684.2

(51) Int. Cl. F16J 15/12

(52) U.S. Cl. CPC F16J 15/123

(57) ABSTRACT

A sealing gasket includes an outer flange, an inner flange, and a seal. The outer flange comprises a first surface and a second surface, parallel to the first surface and comprises a first opening, centered on a first opening axis, wherein said first opening is ringed by an inside edge of the outer flange, connecting the first surface and the second surface. The inner flange, is arranged inside the first opening and the inner flange is connected to the outer flange through at least one junction tab, the inner flange, the outer flange and each junction tab being made of metal. The seal, is made of elastomer, provided on the inside edge and protrudes from the first surface and the second surface.

### TECHNICAL FIELD

The disclosure relates generally to gaskets. In particular aspects, the disclosure relates to a sealing gasket and a vehicle comprising such a sealing gasket. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Sealing gaskets, to prevent fluid form leaking are known. Some types of sealing gaskets include two parts, an outer part surrounding an inner part, the outer part and the inner part being connected via connecting tabs. In these cases, the outer part and/or the inner part each have two flat surfaces coated with a layer forming a seal on either surface. These gaskets, while offering satisfactory results in terms of sealing capabilities, use a lot of sealing material, as the entirety of the two surfaces of the outer part and/or the inner part need to be coated in sealing material.

However, having a seal that covers only partially the surfaces is difficult to achieve on flat surfaces, and such a seal will be easily removable, or will be susceptible to damage when the gasket is in use, reducing its durability. Therefore, it is necessary to have a seal that is not easily removed when the gasket is used and will ensure a long shelf life of the gasket.

### SUMMARY

The aim of the invention is to have a sealing gasket, comprising a seal that will not be removed or damaged easily when it is used.

According to a first aspect of the disclosure, the invention relates to a sealing gasket, made of metal, comprising:
an outer flange, wherein the outer flange is essentially flat, comprising a first surface and a second surface, parallel to the first surface and comprising a first opening, centered on a first opening axis, wherein said first opening is ringed by an inside edge of the outer flange, connecting the first surface and the second surface;
an inner flange, wherein the inner flange is flat, is arranged inside the first opening and at a distance from the inside edge and wherein the inner flange is connected to the outer flange through at least one junction tab, the inner flange and the outer flange and each junction tab being made of metal; and
a seal, made of elastomer, provided on the inside edge and protruding from the first surface and second surface.

The first aspect of the disclosure may seek to ensure that the seal is not easily damaged when the gasket is used.

A technical benefit may include that the gasket is easy to manufacture and that the seal is durable as it is well secured to the outer flange of the sealing gasket, by being provided on the inside edge, as well as keeping its sealing effect by protruding on the first and second surfaces.

In some examples, including in at least one preferred example, optionally the outer flange, the inner flange and each junction tab are integrally formed with each other. A technical benefit may include easier manufacturing, by eliminating assembly of the outer flange, the inner flange and each junction tab.

In some examples, including in at least one preferred example, optionally the seal is in the form of a bead and extends on the first surface and the second surface. A technical benefit may include a better sealing effect.

In some examples, including in at least one preferred example, optionally the inside edge forms a bead, integrally formed with the outer flange and the seal is provided on the bead. A technical benefit may include that a smaller quantity of seal is used.

In some examples, including in at least one preferred example, optionally each junction tab extends from the inside edge to the inner flange. A technical benefit may include that the junction tabs do not affect sealing.

In some examples, including in at least one preferred example, optionally the inner flange comprises a second opening coaxial to the first opening. A technical benefit may include that an object can be positioned coaxial to both openings.

In some examples, including in at least one preferred example, optionally the second opening is circular. A technical benefit may include that the gasket can be used with other circular objects that also have a circular opening.

In some examples, including in at least one preferred example, several junction tabs are provided, being regularly spaced around the first opening axis. A technical benefit may include that the inner flange's properties, such as rigidity are homogeneous around the first opening axis, and easier deposition of the seal.

In some examples, including in at least one preferred example, optionally the first opening is circular. A technical benefit may include easier manufacturing of the gasket.

In some examples, including in at least one preferred example, optionally the inner flange has an annular shape. A technical benefit may include that the inner flange can be interposed between objects that have an annular form without protruding.

In some examples, including in at least one preferred example, the outer flange further comprises at least one additional hole configured for receiving a fastener. A technical benefit may include that the gasket can be fastened to a surface.

In some examples, including in at least one preferred example, the outer flange further comprises a coating. A technical benefit may include that the outer flange has additional properties not achievable if the outer flange is an uncoated metal.

In some examples, including in at least one preferred example, optionally the coating is an elastomeric coating. A technical benefit may include increasing the sealing effect of the gasket.

In some examples, including in at least one preferred example, optionally each junction tab has a thickness, measured along the first opening axis, comprised between 0.3 and 1 millimeters, preferably between 0.5 and 0.7 millimeters. A technical benefit may include that the junction tabs are rigid enough to support the inner flange and additional load while limiting their thickness.

In some examples, including in at least one preferred example, a thickness measured from the first surface to the second surface along the first opening axis is comprised between 1 and 1.5 millimeters, preferably between 1.1 and 1.3 millimeters. A technical benefit may include that the gasket can be inserted into a space to properly seal the space.

According to a second aspect of the disclosure, the invention relates to a vehicle, comprising:
a first carter;
a second carter, facing the first carter according to a first axis;
a bearing, received inside a cavity of the first carter and facing the second carter along the first axis;
a shim, interposed between the bearing and the second carter along the first axis; and
the gasket according to any of the examples cited above, wherein the outer flange is interposed between the first carter and the second carter along the first axis and the inner flange is interposed between the shim and the second carter along the first axis and wherein the inner flange exerts a load on the shim, which in turn exerts a load on the bearing.
   The second aspect of the disclosure may seek to seal a space between elements of a vehicle. A technical benefit may include that the gasket used for sealing is easy to manufacture and durable and can also act as a load bearing element, thus limiting the number of parts in the vehicle.

In some examples, including in at least one preferred example, optionally the gasket is fastened to the first carter by screws. A technical benefit may include that the gasket is less likely to move and will seal more efficiently.

In some examples, including in at least one preferred example, optionally the first carter contains oil and the gasket is oil-tight. A technical benefit may include preventing leaking of oil in the vehicle.

In some examples, including in at least one preferred example, optionally the gasket is watertight. A technical benefit may include preventing water from penetrating inside the vehicle.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary view of a vehicle and an exploded view of a part of a vehicle according to an example.

FIG. 2 is a cross sectional view of the part of the vehicle of FIG. 1.

FIG. 3 is a perspective view of a gasket shown on FIG. 1.

FIG. 4 is a cross sectional view of the gasket of FIG. 3 along the AA′ plane of FIG. 3.

FIG. 5. is a view similar to FIG. 4, showing a gasket according to another example.

### DETAILED DESCRIPTION

The detailed description set forth below provides information and examples of the disclosed technology with sufficient detail to enable those skilled in the art to practice the disclosure.

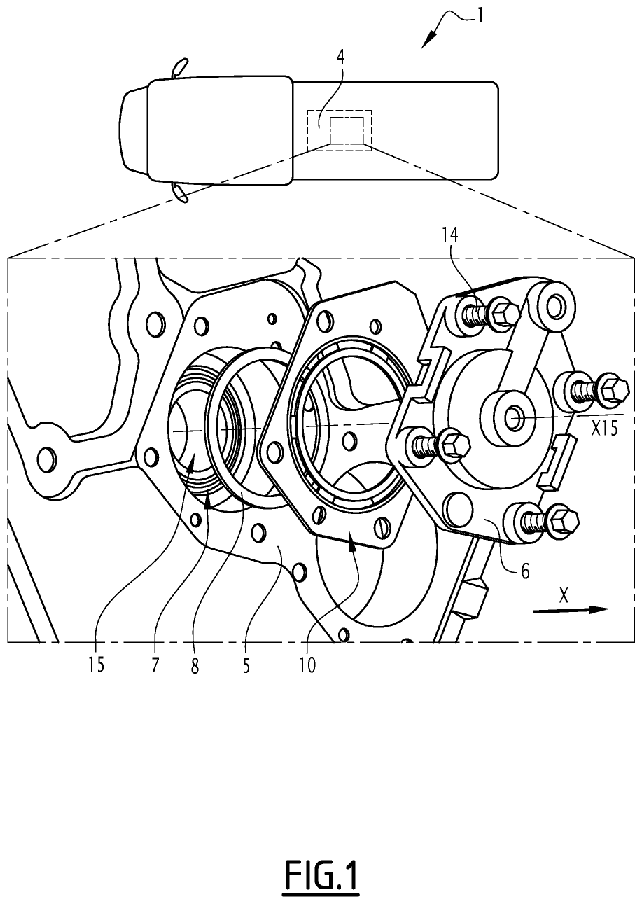

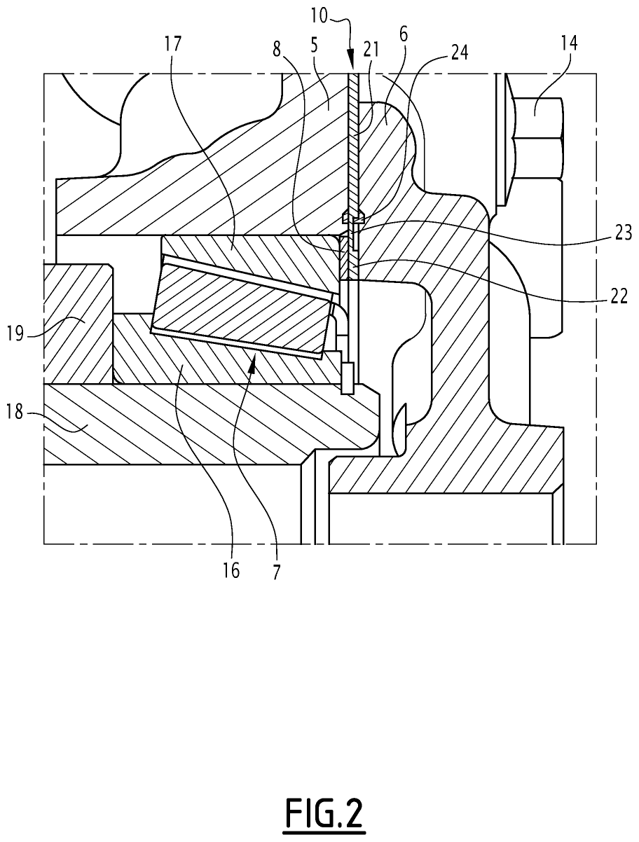

A detail of a vehicle 1 is shown in FIGS. 1 and 2. The vehicle 1 is for example, a truck, a bus, or a construction equipment. The vehicle 1 may be a thermal vehicle or an electrical vehicle. The vehicle 1 is very schematically represented in FIG. 1 and comprises a gearbox 4. The gearbox 4 comprises a first carter 5, a second carter 6, a bearing 7, a shim 8 and a sealing gasket 10, also called gasket 10 hereafter.

The first and second carters 5 and 6 face each other along a first axis X. The first carter 5 may contain oil, which can be at risk of leaking out of the first carter 5.

The first carter 5 comprises a cavity 15, extending along a cavity axis X15, parallel to the first axis X. The cavity 15 receives the bearing 7 and the shim 8. The bearing 7 may be a tapered roller bearing as shown in FIG. 2, but the bearing 7 may alternatively be a ball bearing, or any other type of rolling-element bearing. Here, the bearing 7 comprises an inner race 16 and an outer race 17. The inner race 16 is mounted on an axle 18, shown in FIG. 2. The axle 18 is received in the cavity 15 and is coaxial to the cavity 15. The axle 18 may comprise a bushing 19, preventing the bearing 7 from moving along the axle 18 along the axis X15. The outer race 17 is in contact with the shim 8 along the first axis X. The shim 8 is circular, with a central opening centered on the cavity axis X15, so that the shim 8 is in contact with only the outer race 17 of the bearing 7.

The second carter 6 may face the cavity 15, and in particular the bearing 7, along the first axis X. In particular, the second carter 6 may cover the cavity 15 and the bearing 7 to protect the bearing 7 from outside elements. The second carter 6 may also prevent the bearing 7 from moving along the axis X15 and falling from the cavity 15. In order to do so, the second carter 6 is fixed to the first carter 5, using screws 14. In other examples, not represented, the second carter 6 is fixed to the first carter 5 by fasteners other than screws 14.

The gasket 10 is interposed between the shim 8 and the first carter 5 on a first side, and the second carter 6 on another side along the first axis X. The gasket 10 may be received in a recess of the first carter 5, surrounding the cavity 15, in order to facilitate correct positioning. The gasket 10 is used to seal a space between the first and second carters 5 and 6, and thus ensures that no leakage, for example of oil, is possible from the first carter 5 to an outside of the first carter 5. The gasket 10 is also used to apply a load on the shim 8. The load applied by the gasket 10 on the shim 8 is applied along the axis X15, in the direction of the gasket 10 to the shim 8. The outer race 17 of the bearing 7 is loaded along the axis X15 in order to block any movement of the bearing 7 along the axis X15 that could be caused by play.

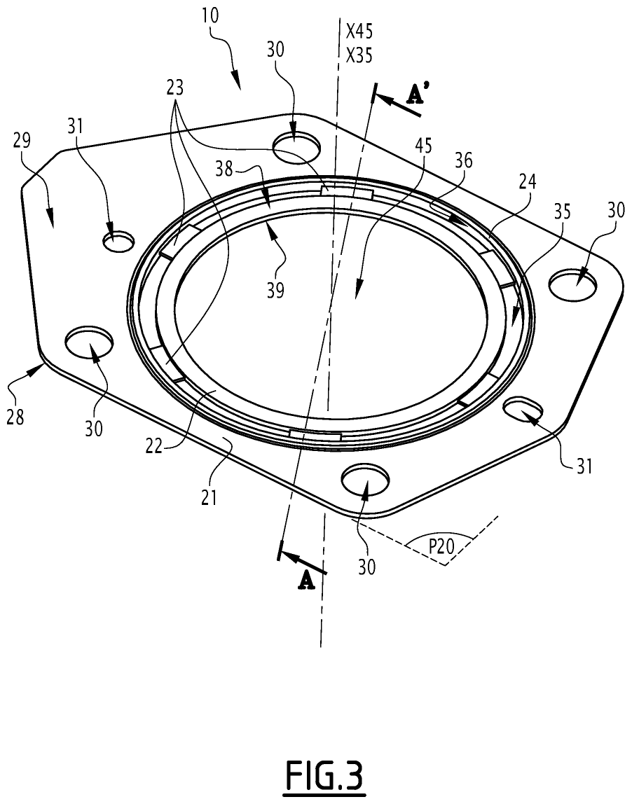

The gasket 10 is shown alone on FIG. 3. To fulfill properly the sealing and the loading function, the gasket 10 comprises an outer flange 21, an inner flange 22, junction tabs 23 and a seal 24. Alternatively, the gasket 10 comprises one junction tab 23. In any case, the gasket 10 comprises at least one junction tab 23. The gasket 10 is essentially flat and extends along a plane P20. The outer flange 21 is flat, and has a first surface 28 extending along the plane P20 and a second surface 29 parallel to the first surface 28. When the gasket 10 is in use, the outer flange 21 is interposed between the first carter 5 and the second carter 6 along the axis X15. The outer flange 21 comprises through holes 30 and 31, extending from the surface 28 to the surface 29 and configured for receiving respective fasteners. Such fasteners may be the screws 14 used to fasten the first and the second carter 5 and 6 together, screws 14 which are then also used to fasten the gasket 10 to the first carter 5. Alternatively, the fasteners may be other fasteners that solely fasten the gasket 10 to the first carter 5. As a variant, a combination of both types of fasteners may be used. In the examples shown in FIGS. 1 to 3, the outer flange 21 comprises four holes 30 for receiving the screws 14, and two holes 31 for receiving other fasteners, not shown. The outer flange 21 may also comprise only one hole 30 or 31.

The outer flange 21 further comprises a first opening 35, centered on a first opening axis X35. The first opening 35 is circular in the examples represented, however in other examples, the first opening 35 may be of a different shape. The first opening 35 extends through the outer flange 21, from the first surface 28 to the second surface 29, and an inside edge 36, ringing the first opening 35, connects the first and second surfaces 28 and 29. The inside edge 36 is flat, in that, for any cross-section of the inside edge 36 along a plane containing the first opening axis X35, the cross-section of the inside edge 36 is parallel to the first opening axis X35. The inside edge 36 further faces the first opening axis X35.

The outer flange 21 may have a thickness, measured from the first surface 28 to the second surface 29 along the first opening axis X35, comprised between 1 and 1.5 millimeters, preferably between 1.1 and 1.3 millimeters. Typically, the outer flange 21 is made of metal such as stainless steel.

The inner flange 22 is located inside the first opening 35. When the gasket 10 is in use, the inner flange 22 is interposed between the shim 8 and the second carter 6 along the axis X15. The inner flange 22 is made of metal, such as stainless steel, is flat, and located at a distance from the inside edge 36, such that the inner flange 22 and the inside edge 36 are not in contact. In the example of FIGS. 1 to 3, the first opening 35 is circular and the inner flange 22 is also circular, to maintain a constant distance between the inner flange 22 and the inside edge 36. The inner flange 22 may have a first surface 38 extending along the first plane P20 and a second surface 39 extending parallel to the first surface 38.

The inner flange 22 may comprise a second opening 45, as shown in the FIGS. 1 to 3. The opening 45 may be circular and centered on a second axis X45, and coaxial with the first opening 35. Thus, the axes X35 and X45 coincide here. A diameter of the second opening 45 may be equal to a diameter of the shim 8. In some examples, and as shown in the FIGS. 1 to 3, the inner flange 22 and the second opening 45 are both circular, making the inner flange 22 annular in shape. The inner flange 22 is rigid enough not to deform when the inner flange 22 is pressed against the shim 8 and applies load to the bearing 7.

The junction tabs 23 connect the inner flange 22 and the outer flange 21 to each other. In the examples depicted by the FIGS. 1 to 3, the gasket 10 comprises six junction tabs 23. Each junction tab 23 is flat, parallel to the plane P20 and extends from the inside edge 36 to the inner flange 22. The junction tabs 23 may be regularly spaced around the first opening axis X35, so that the properties of the inner flange 22 properties, such as rigidity, are homogeneous around the first opening axis X35. The junction tabs 23 are rigid enough not to deform when the inner flange 22 is pressed against the shim 8 and applies load to the bearing 7. The junction tabs 23 may have a thickness, measured along the axis X35, comprised between 0.3 and 1 millimeters, preferably between 0.5 and 0.7 millimeters.

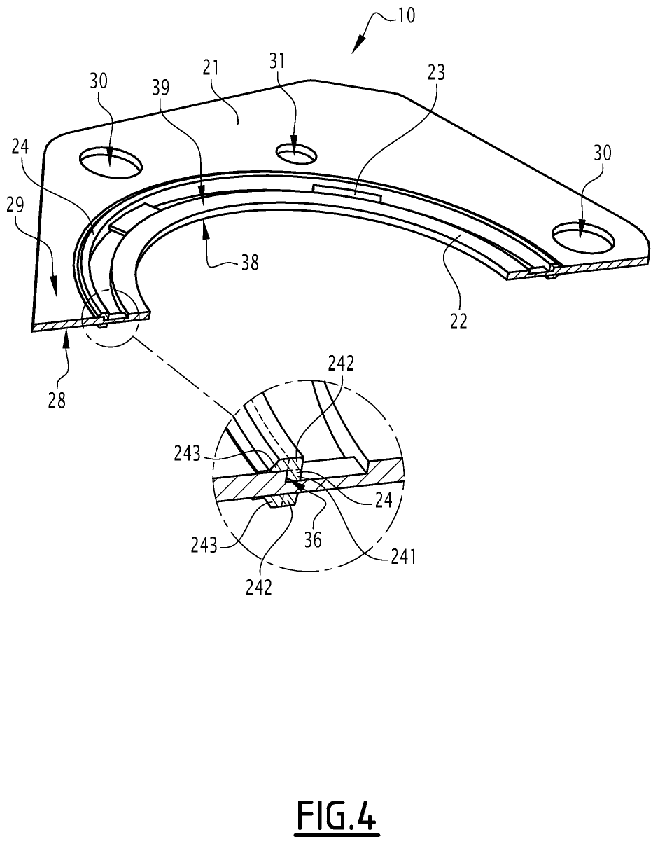

The outer flange 21, inner flange 22 and junction tabs 23 are preferably formed integrally with each other, for example by being stamped from the same initial piece of metal. The first surfaces 28 and 38 of the outer flange 21 and inner flange 22 may be level with each other and the second surfaces 29 and 39 of the outer flange 21 and the inner flange 22 may be level with each other, as shown in FIG. 4.

The seal 24 is provided on the inside edge 36 of the outer flange 21. The seal 24 comprises an inside edge portion 241, two protruding portions 242 and two surface portions 243. The inside edge portion 241 is located on the inside edge 36 of the outer flange 21. The inside edge is also in contact with a portion of each junction tab 23, where each junction tab 23 extends from the inside edge 36. The protruding portions 242 protrude from the first and second surfaces 28 and 29. The two surface portions 243 extend from the protruding portions 242 on the first and second surfaces 28 and 29. The seal 24 is, in this example, in the shape of a bead around the inside edge 36, protruding from the first and second surfaces 28 and 29 and extending on the first and second surfaces 28 and 29. As another example, not shown, the seal 24 only comprises the inside edge portion 241 and the two protruding portions 242.

The fact that the seal 24, in particular the inside edge portion 241 is provided on the inside edge 36 of the outer flange 21 allows for the seal 24 to be deposited on the outer flange 21 more easily, for example by injection molding, while being difficult to remove or damage during use. The two surface portions 243 in particular may further decrease the risk of removing or damaging the seal 24. The use of junction tabs 23, regularly spaced around the inner flange 22, also enable easier deposition and better resistance to damage of the seal 24. The seal 24 is an elastomer, for example acrylonitrile butadiene rubber, also called nitrile or NBR, hydrogenated nitrile butadiene rubber, or silicone. Thus, the seal 24 is oil-resistant. The seal 24 may also be water-resistant, so that the gasket is respectively oil-tight or water-tight. The seal 24 may be both water-and-oil-tight, and/or made of an elastomer resistant to other liquids.

When the gasket 10 is in use in the vehicle 1, first opening axis X35 and the cavity axis X15 coincide. The seal 24 is interposed between the first and second carters 5 and 6 and has a sealing effect between the first and second carters 5 and 6, for example through the elastic deformation of the seal 24. Thus, liquid, such as oil, that may leak from the first carter 5, is unable to spread past the gasket 10. Optionally, if the gasket 10 is water-tight, water, for example coming from outside the vehicle 1 is unable to penetrate to the first and second carters 5 and 6 and reach the bearing 7.

As an addition that may be combined with the previously described examples, the outer flange 21 may comprise a coating on either surface 28 or 29, or alternatively, on both surfaces 28 and 29. Such coating may be an elastomeric coating, made for example of nitrile or silicone. Such coating may be water and/or oil tight, and/or may increase a sealing effect between the outer flange 21 and the first and second carters 5 and 6, thus reinforcing the sealing effect of the gasket 10.

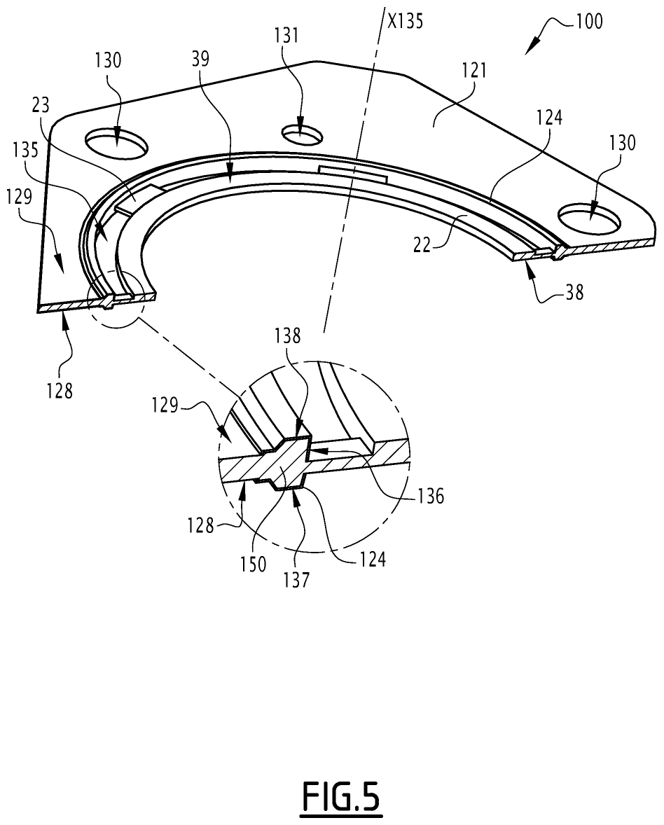

FIG. 5 shows a gasket 100 according to another example. Aspects of the gasket 100 that are identical to the gasket 10 described in FIGS. 1 to 4 are referenced with the same reference numbers and are not discussed again. The gasket 100 may be used in an identical manner than the gasket 10 in the vehicle 1.

The gasket 100 of FIG. 5 differs from the example gasket 10 shown in FIG. 4 in that an outer flange 121 replaces the outer flange 21 and that a seal 124 replaces the seal 24. The outer flange 121 comprises a first surface 128, a second surface 129, holes 130 and 131, a first opening 135 and an inside edge 136. The first surface 128, second surface 129, holes 130 and 131 and the first opening 135 are respectively similar to the first surface 28, the second surface 29, the holes 30 and 31 and the first opening 35 of the outer flange 21. The first opening 135 is centered along a first opening axis X135. The inside edge 136 connects the first and second surfaces 128 and 129, but is not flat like the inside edge 36 of the outer flange 21. The inside edge 136 comprises a portion that does face the first opening axis X135, similar to the inside edge 36, but also comprises two portions 137 and 138 that do not face the first opening axis X135 but are parallel to the opening 135, and that protrude from the first and second surfaces 128 and 129. The inside edge 136 thus forms a bead 150. The bead 150 is formed integrally with the outer flange 121, inner flange 22 and junction tabs 23, and may be thus made of metal. Thus, the outer flange 121 is essentially flat, as the first and second surfaces 128 and 129 are still parallel to each other but the bead 150 protrudes from the first and second surfaces 128 and 129 along the axis X135.

The seal 124 is made of the same material as the seal 24. The seal 124 differs from the seal 24 in that it is a layer that covers the inside edge 136, or in other words, that covers the bead 150. As the bead 150 protrudes from the first and second surfaces 128 and 129, the seal 124 protrudes from the first and second surfaces 128 and 129. As an alternative that is not shown, the seal 124 may extend on the first and second surfaces 128 and 129.
Example 1: A sealing gasket 10 or 100, comprising:
an outer flange 21 or 121, wherein the outer flange 21 or 121 is essentially flat, comprising a first surface 28 or 128 and a second surface 29 or 129, parallel to the first surface 28 or 128 and comprising a first opening 35 or 135, centered on a first opening axis X35 or X135, wherein said first opening 35 or 135 is ringed by an inside edge 36 or 136 of the outer flange 21 or 121, connecting the first surface 28 or 128 and the second surface 29 or 129;
an inner flange 22, wherein the inner flange 22 is flat, is arranged inside the first opening 35 and at a distance from the inside edge 36 or 136 and wherein the inner flange 22 is connected to the outer flange 21 or 121 through at least one junction tab 23, the inner flange 22 and the outer flange 21 or 121 and each junction tab 23 being made of metal; and
a seal 24 or 124, made of elastomer, provided on the inside edge 36 or 136 and protruding from the first surface 28 or 128 and the second surface 29 or 129.
Example 2: The gasket 10 or 100 of example 1, wherein the outer flange 21 or 121, the inner flange 22 and each junction tab 23 are integrally formed with each other.
Example 3: The gasket 10 of example 1 or 2, wherein the seal 24 is in the form of a bead and extends on the first surface 28 and the second surface 29.
Example 4: The gasket 100 of example 1 or 2, wherein the inside edge 36 forms a bead 150, integrally formed with the outer flange 121 and the seal 124 is provided on the bead 150.
Example 5: The gasket 10 or 100 of examples 1 to 4, wherein each junction tab 23 extends from the inside edge 36 or 136 to the inner flange 22.
Example 6: The gasket 10 or 100 of examples 1 to 5, wherein the inner flange 22 comprises a second opening 45 coaxial to the first opening 35 or 135.
Example 7: The gasket 10 or 100 of example 6, wherein the second opening 45 is circular.
Example 8: The gasket 10 or 100 of examples 1 to 7, the at least one junction tab 23 includes several junction tabs which are regularly spaced around the first opening axis X35 or X135.
Example 9: The gasket 10 or 100 of examples 1 to 8, wherein the first opening 35 or 135 is circular.
Example 10: The gasket 10 or 100 of examples 1 to 9, wherein the inner flange 22 has an annular shape.
Example 11: The gasket 10 or 100 of examples 1 to 10, wherein the outer flange 21 or 121 further comprises at least one additional hole 30, 31, 130 or 131 configured for receiving a fastener 14.
Example 12: The gasket 10 or 100 of examples 1 to 11, wherein the outer flange 21 or 121 further comprises a coating.
Example 13: The gasket 10 or 100 of example 12, wherein the coating is an elastomeric coating.
Example 14: The gasket 10 or 100 of examples 1 to 13, wherein each junction tab 23 has a thickness, measured along the first opening axis X35 or X135, comprised between 0.3 and 1 millimeters, preferably between 0.5 and 0.7 millimeters.
Example 15: The gasket 10 or 100 of examples 1 to 14, wherein a thickness measured from the first surface 28 or 128 to the second surface 29 or 129 along the first opening axis X35 or X135 is comprised between 1 and 1.5 millimeters, preferably between 1.1 and 1.3 millimeters.
Example 16: A vehicle 1, comprising:
a first carter 5;
a second carter 6, facing the first carter 5 according to a first axis X;
a bearing 7, received inside a cavity 15 of the first carter 5 and facing the second carter 6 along the first axis X; a shim 8, interposed between the bearing 7 and the second carter 6 along the first axis
X; and
the gasket 10 or 100 according to any of the examples 1 to 15, wherein the outer flange 21 or 121 is interposed between the first carter 5 and the second carter 6 along the first axis X and the inner flange 22 is interposed between the shim 8 and the second carter 6 along the first axis X and wherein the inner flange 22 exerts a load on the shim 8, which in turn exerts a load on the bearing 7.
Example 17: The vehicle 1 of example 16, wherein the gasket 10 or 100 is fastened to the first carter 5 by screws 14.
Example 18: The vehicle 1 of example 16 or 17, wherein the first carter 5 contains oil and the gasket 10 or 100 is oil-tight.
Example 19: The vehicle 1 of example 16 or 17, wherein the gasket 10 or 100 is water-tight.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A sealing gasket, comprising:
an outer flange, wherein the outer flange is essentially flat, comprising a first surface and a second surface, parallel to the first surface and comprising a first opening, centered on a first opening axis, wherein said first opening is ringed by an inside edge of the outer flange, connecting the first surface and the second surface;
an inner flange, wherein the inner flange is flat, is arranged inside the first opening and at a distance from the inside edge and wherein the inner flange is connected to the outer flange through at least one junction tab, the inner flange, the outer flange and each junction tab being made of metal; and
a seal, made of elastomer, provided on the inside edge and protruding from the first surface and the second surface.

2. The gasket of claim 1, wherein the outer flange, the inner flange and each junction tab are integrally formed with each other.

3. The gasket according to claim 1, wherein the seal is in the form of a bead and extends on the first surface and the second surface.

4. The gasket according to claim 1, wherein the inside edge forms a bead, integrally formed with the outer flange and the seal is provided on the bead.

5. The gasket according to claim 1, wherein each junction tab extends from the inside edge to the inner flange.

6. The gasket according to claim 1, wherein the inner flange comprises a second opening coaxial to the first opening.

7. The gasket according to claim 6, wherein the second opening is circular.

8. The gasket according to claim 1, wherein the at least one junction tab includes several junction tabs which are regularly spaced around the first opening axis.

9. The gasket according to claim 1, wherein the first opening is circular.

10. The gasket according to claim 1, wherein the inner flange has an annular shape.

11. The gasket according to claim 1, wherein the outer flange further comprises a coating.

12. A vehicle, comprising:
a first carter;
a second carter, facing the first carter according to a first axis;
a bearing, received inside a cavity of the first carter and facing the second carter along the first axis;
a shim, interposed between the bearing and the second carter along the first axis; and
the gasket according to claim 1, wherein the outer flange is interposed between the first carter and the second carter along the first axis and the inner flange is interposed between the shim and the second carter along the first axis and wherein the inner flange exerts a load on the shim, which in turn exerts a load on the bearing.

13. The vehicle according to claim 12, wherein the gasket is fastened to the first carter by screws.

14. The vehicle according to claim 12, wherein the first carter contains oil and the gasket is oil-tight.

15. The vehicle according to claim 12, wherein the gasket is water-tight.
